(19) United States
(12) Patent Application Publication
(10) Pub. No.: US 2025/0295114 A1
(43) Pub. Date: Sep. 25, 2025

(54) USE OF A POLYCARBOXYLATE COPOLYMER AND ALKYL ETHER SULFATE AS COMPATIBILIZER IN TANK MIX COMPOSITION

(71) Applicants: QUIMICOS E. SOLUCOES SUSTENTAVEIS DO BRASIL S.A., Jardim Sao Luis, CEP (BR); SPECIALTY OPERATIONS FRANCE, Lyon (FR)

(72) Inventors: Vanessa Rodrigues Golfetti Da Silva, Paulinia (BR); Jeferson Dos Santos Junior, Campinas SP (BR); Fernanda De Oliveira Barreto Costa, Paulinia-SP (BR); Rawad Tadmouri, Bordeaux (FR)

(73) Assignees: QUIMICOS E. SOLUCOES SUSTENTAVEIS DO BRASIL S.A., Jardim Sao Luis, CEP (BR); SPECIALTY OPERATIONS FRANCE, Lyon (FR)

(21) Appl. No.: 18/864,465

(22) PCT Filed: May 11, 2022
(86) PCT No.: PCT/EP2022/062845

§ 371 Date: Nov. 8, 2024

(51) Int. Cl. A01N 47/26; A01N 25/02; A01N 35/10; A01N 37/34; A01N 37/38; A01N 43/40; A01N 43/54; A01N 43/56; A01N 43/84; A01N 43/86; A01N 47/34; A01N 47/36; A01N 57/20; A01P 3/00; A01P 7/04; A01P 13/00; C05G 3/60

(52) U.S. Cl. CPC A01N 47/26; A01N 25/02; A01N 35/10; A01N 37/34; A01N 37/38; A01N 43/40; A01N 43/54; A01N 43/56; A01N 43/84; A01N 43/86; A01N 47/34; A01N 47/36; A01N 57/20; A01P 3/00; A01P 7/04; A01P 13/00; C05G 3/60

(57) ABSTRACT

The present invention relates to an agricultural tank-mix composition, comprising an agricultural active composition and a compatibilizer selected from a composition containing a copolymer comprising units of diisobutylene and methacrylic anhydride or methacrylic acid and C10-C16 alkyl ether sulfate salt.

### FIELD OF THE INVENTION

The present invention relates to an agricultural tank-mix composition, comprising an agricultural active composition and a compatibilizer selected from a composition containing a copolymer of a polycarboxylate and alkyl ether sulfate. The present invention further relates to the use of such a composition as a compatibilizer in tank mix composition.

### BACKGROUND

For many purposes in agriculture and related endeavors it is desired to apply simultaneously two or more biologically active compounds, each of which is a pesticide or plant growth regulator, to the same locus. This is best accomplished by including the two or more compounds in a single composition, which is applied for example by spraying to target plants or soil. Frequently such a composition is prepared by the user in the field by adding measured amounts of two or more concentrated compositions of the individual formulation of active ingredients to water in a spray tank, sometimes together with other ingredients. A composition prepared in this way is often known as a “tank-mix”.

Each formulated product has a set of complex chemical structures. As a result, each tank-mix partner increases the potential for both physical and chemical incompatibilities, for example sedimentation or flocculation, which can negatively affect spray application and effectiveness of crop protection products. Polycarboxylate copolymers are a commonly used dispersant for pesticide formulation, for example, WO 9918787 A disclose that copolymers of an α,β-unsaturated oxyacid and an olefin can be used as in-built dispersant to improve the physical stability and/or dispersion performance of the agrochemical composition comprising the same. Typically, in-built dispersant is in an amount ranging from 1 to 10 wt. % based on the total weight of the agrochemical composition, and will be diluted more than 200 times during the operation, higher amount of the in-built dispersant is avoided for the reason of saving cost or impairing formulation stability.

However, the increasing complexity of tank-mix combinations of agrochemicals leads to an increased tendency for incompatibilities between active ingredients that ultimately can cause poor performance, crop injury and clog sprayers.

Therefore, there is still no technology available to identify/develop tank mix compatibility that not only reduces or eliminates the incompatibility issue, but also contributes to time savings and reduced application costs.

### SUMMARY OF THE INVENTION

It was surprisingly found by the applicant that a composition of a polycarboxylate copolymer and alkyl ether sulfate can be added to tank-mix composition on the purpose of improving compatibility thereof.

In one aspect of the present invention, it is provided agricultural tank-mix composition comprising an agricultural active composition and a composition comprising a copolymer comprising units of diisobutylene and methacrylic anhydride or methacrylic acid and C10-C16 alkyl ether sulfate salt as compatibilizer.

In another aspect of the present invention, it is provided the use of a composition comprising a copolymer comprising units of diisobutylene and methacrylic anhydride or methacrylic acid and C10-C16 alkyl ether sulfate salt as compatibilizer to stabilize the agricultural active composition.

In still another aspect of the present invention, it is provided a process of preparing a tank mix composition, comprising the steps of mixing a composition comprising a copolymer comprising units of diisobutylene and methacrylic anhydride or methacrylic acid and C10-C16 alkyl ether sulfate salt as compatibilizer with an agricultural active composition.

### DETAILED DESCRIPTION OF THE INVENTION

Throughout the description, including the claims, the term “comprising one” or “comprising a” should be understood as being synonymous with the term “comprising at least one”, unless otherwise specified. The terms “between” and “from . . . to . . . ” should be understood as being inclusive of the limits. The articles “a”, “an” and “the” are used to refer to one or to more than one (i.e., to at least one) of the grammatical object of the article.

It should be noted that in specifying any range of concentration, weight ratio or amount, any particular upper concentration, weight ratio or amount can be associated with any particular lower concentration, weight ratio or amount, respectively.

As used herein, the term “alkyl” means a saturated hydrocarbon radical, which may be straight, branched or cyclic, such as, decane, undecane, dodecane, tridecane, tetradecane, pentadecane, hexadecane.

As used herein, the terminology “(Cn-Cm)” in reference to an organic group, wherein n and m are each integers, indicates that the group may contain from n carbon atoms to m carbon atoms per group.

As used herein, the ratios L/ha, g/ha and Kg/ha refers to the amount of the product in the tank-mix composition to reach the amount of each compound applied by hectare, according to the agrochemical formulation use.

In one aspect of the present invention, it is provided an agricultural tank-mix composition, comprising:
a) an agricultural active composition comprising at least two pesticides selected from dithiocarbamate fungicide, chlorothalonil, glyphosate, flumioxazine, estrobilurin fungicide, pyrazole-carboxamide fungicide, benzoylurea insecticide, neonicotinoid insecticide, pyrethroid insecticide, phenoxy herbicide, pyrimidinedione herbicide, sulfonylurea herbicide, cyclohexanediones herbicide and benzoic acid herbicide, and
b) a compatibilizer selected from a composition comprising a copolymer comprising units of diisobutylene and methacrylic anhydride or methacrylic acid and C10-C16 alkyl ether sulfate salt, wherein the compatibilizer composition is present in an amount of ranging from 0.1 to 5 wt. %, preferably 0.2 to 3 wt. %, more preferably from 0.2 to 1.5 wt %, based on the total weight of the agricultural tank-mix composition.

The agricultural tank-mix composition as provided in the present invention has improved compatibility on addition the composition comprising a copolymer comprising units of diisobutylene and methacrylic anhydride or methacrylic acid and C10-C16 alkyl ether sulfate salt as compatibilizer, which in turn bring the benefit for example, but not limited to, no nozzle blockage, easy tank cleaning.

Advantageously, the compatibilizer can be added in high amounts to in-built compositions without prejudice to the stability of the composition. Particularly, the compatibilizer is added in-built in an amount necessary to achieve the compatibilizer amount when diluted in the agricultural tank-mix composition.

The compatibilizer is a composition comprising a copolymer comprising a polycarboxylate copolymer and a C10-C16 alkyl ether sulfate salt. Polycarboxylates are polymers, which may comprise carboxylic acid groups in free acid form and/or as salt.

According to one advantageous embodiment, the polycarboxylate comprises units derived specifically from methacrylic anhydride or from a methacrylic acid and from diisobutylene.

Advantageously, the compatibilizer composition copolymer comprises units derived from diisobutylene and methacrylic anhydride or methacrylic acid and C10-C16 alkyl ether sulfate salt.

It is noted that the copolymers may be obtained in a manner known to those skilled in the art, for example by free-radical polymerization in the presence of a catalyst using solvent, such as, for example, benzene, toluene, xylene, dioxane, ethyl acetate or possibly the diisobutylene compound which is used in substantial excesses.

The catalysts generating free radicals which are suitable for synthesis of the copolymers of the present invention are in most cases peroxides or hydroperoxides azo compounds, such as, for example, acetyl peroxide, di-tert-butyl peroxide, benzoyl peroxide, lauroyl peroxide, tert-butyl perbenzoate, methyl hydroperoxide, ethyl hydroperoxide, tert-butyl hydroperoxide, cumene hydroperoxide, azodiisobutyronitrile and dimethyl azoisobutyrate.

The preferred copolymers are those which have a mean molecular weight of from 5,000 to 60,000 Daltons and preferably from 12,000 to 42,000 Daltons.

The tank-mix composition may comprise a wide variety of insoluble pesticides.

Particularly, the tank-mix composition of the present invention can comprise complex mixtures including, but not limited to herbicides, insecticides, fungicides, biocides, molluscicides, algaecides, anthelmintics, rodenticides, nematocides, acaricides, amoebicides and protozoacides.

In a preferred embodiment of the present invention, the at least one pesticide is selected from dithiocarbamate fungicide, chlorothalonil, glyphosate, flumioxazine, estrobilurin fungicide, pyrazole-carboxamide fungicide, benzoylurea insecticide, neonicotinoid insecticide, pyrethroid insecticide, phenoxy herbicide, pyrimidinedione herbicide, sulfonylurea herbicide, cyclohexanediones herbicide and benzoic acid herbicide or the combination thereof.

In the present invention, the dithiocarbamate of the agricultural tank-mix composition is selected from mancozeb, ferbam, maneb, metam, metiram, propineb, thiram, zineb, ziram.

Dithiocarbamate is a functional group in organic chemistry analog of a carbamate, in which both oxygen atoms are replaced by sulfur atoms. It is a class of fungicides with poor water solubility.

In a particular preferred embodiment, the dithiocarbamate is selected from mancozeb.

When the dithiocarbamate is used in the form of a solid composition the dithiocarbamate concentration, notably loading, may vary widely, depending on the specific use intended. Typically the composition is in the form of an solid composition containing in the range of from 0.5 to 1000 g/kg dithiocarbamate and preferably from 50 to 950 g/kg dithiocarbamate.

Alternatively, dithiocarbamate can be used in an aqueous liquid composition containing in the range of from 0.5 to 1000 g/l dithiocarbamate and preferably from 50 to 950 g/l dithiocarbamate.

Chlorothalonil is an organic compound mainly used as a broad spectrum, nonsystemic fungicide, with other uses as a wood protectant, pesticide, acaricide, and to control mold, mildew, bacteria, algae.

When chlorothalonil is used in aqueous liquid composition, the chlorothalonil concentration may vary in the range of from 300 to 800 g/l chlorothalonil and preferably from 400 to 750 g/l chlorothalonil.

Alternatively, chlorothalonil can be used in the form a solid composition containing in the range of from 400 to 950 g/kg chlorothalonil and preferably from 450 to 900 g/kg chlorothalonil.

In the present invention, the glyphosate herbicide refers to glyphosate or the salts thereof. Glyphosate refers to N-(phosphonomethyl)glycine.

In some embodiment of the present invention, the glyphosate herbicide is selected from glyphosate.

Glyphosate is a herbicide having an acid group and that is relatively insoluble in water (1.16% by weight at 25 degrees centigrade). For this reason it is typically formulated as a water-soluble salt in aqueous solution.

In the present invention, glyphosate can be present in its acid form, as well as to glyphosate in the form of any water-soluble agriculturally acceptable salt or derivative thereof, which provides glyphosate acid or glyphosate anions in a solution of a herbicidal composition according to this invention.

Preferably the glyphosate herbicide employed herein is a relatively non-hygroscopic water-soluble glyphosate salt such as an alkali metal, for example sodium, salt, or ammonium salt of glyphosate or a mixture(s) thereof, although any salts of glyphosate which are able to be formulated in a water-soluble dry form, or mixtures of any such salts or a mixture of glyphosate acid and any such salts, may be employed if desired. Most preferred are mono alkali metal salts of N-phosphonomethylglycine and the mono ammonium salt of N-phosphonomethylglycine or mixtures thereof and the like.

In some embodiments, the glyphosate herbicide, particularly glyphosate, presents in the salt form selected from potassium (K) salt, sodium (Na) salt, isopropylamine (IPA) salt, monoethanolamine (MEA) salt, monomethylamine (MMA) salt, triethylamine (TEA) salt, dimethylamine (DMA) salt, trimethylsulphonium salt, and ammonium (NH₃) salt.

When the glyphosate herbicide is used in the form of an aqueous composition, the glyphosate concentration, notably loading, may vary widely, depending on the specific use intended. Typically the composition is in the form of an aqueous solution containing in the range of from 300 to 700 g/l glyphosate (ae, acid equivalent) and preferably from 360 to 700 g/l (ae). Concentrate compositions containing from 360 to 700 g/l (ae) are the most.

Alternatively, glyphosate can be used in a solid form containing in the range of from 500 to 900 g/kg glyphosate (ae, acid equivalent) and preferably from 600 to 900 g/kg glyphosate (ae).

Flumioxazine hebicide is a chemical compound from the group of N-phenylphthalimide derivatives and N-phenylimides. In a particular preferred embodiment, the tank-mix composition of the present invention may contain flumioxazine.

In some embodiments of the present invention, strobilurin fungicide is selected from
Methyl (2E)-2-(2-{[6-(2-cyanophenoxy)pyrimidin-4-yl]oxy}phenyl)-3-methoxyprop-2-enoate (azoxystrobin),
methyl(2E)-2-methoxyimino-2-[2-[(2-methylphenoxy)methyl]phenyl]acetate (kresoxim-methyl),
methyl ester of (2E)-3-methoxy-2-[2-({[6-(trifluoromethyl)pyridin-2-yl]oxy}methyl)phenyl]prop-2-enoic acid (picoxystrobin),
(E)-1-[2-[6-(2-chlorophenoxy)-5-fluoropyrimidin-4-yl]oxyphenyl]-1-(5,6-dihydro-1,4,2-dioxazin-3-yl)-N-methoxymethanimine (fluoxastrobin),
(2E)-2-[2-[[(E)-[(3E,4E)-3,4-bis(methoxyimino)pentan-2-ylidene]amino]oxymethyl]phenyl]-2-methoxyimino-N-methylacetamide (orysastrobin),
(2E)-2-[2-[(2,5-dimethylphenoxy)methyl]phenyl]-2-methoxyimino-N-methylacetamide (dimoxystrobin),
Methyl N-[2-[[1-(4-chlorophenyl)pyrazol-3-yl]oxymethyl]phenyl]-N-methoxycarbamate (pyraclostrobin), and
methyl (2Z)-2-methoxyimino-2-[2-[[(E)-1-[3-(trifluoromethyl)phenyl]ethylideneamino]oxymethyl]phenyl]acetate (trifloxystrobin).

Preferably, the strobilurin fungicide azoxystrobin.

In some embodiments of the present invention, the pyrazole-carboxamide fungicide is selected from
N-[11-(dichloromethylidene)-3-tricyclo[6.2.1.02,7]undeca-2(7),3,5trienyl]-3-(difluoromethyl)-1-methylpyrazole-4-carboxamide (benzovindiflupyr),
3-(Difluoromethyl)-1-methyl-N-(3′,4′,5′-trifluoro[1,1-biphenyl]-2-yl)-1H-pyrazole-4-carboxamide (fluxapyroxad),
N-[2-(3,4-dichlorophenyl)-4-fluorophenyl]-3-(difluoromethyl)-1-methylpyrazole-4-carboxamide (bixafen), and
3-(difluoromethyl)-1-methyl-N-[(3R)-1,1,3-trimethyl-2,3-dihydroinden-4-yl]pyrazole-4-carboxamide (Inpyrfluxam)

Preferably, the pyrazole-carboxamide fungicide is selected from benzovindiflupyr.

In some embodiments of the present invention, the benzoylurea insecticide is selected from
N-[(3,5-dichloro-2,4-difluorophenyl)carbamoyl]-2,6-difluoro benzamide (teflubenzuron),
N-[(4-Chlorophenyl)carbamoyl]-2,6-difluorobenzamide (diflubenzuron),
N-[[4-[2-chloro-4-(trifluoromethyl)phenoxy]-2-fluorophenyl]carbamoyl]-2,6-difluorobenzamide (flufenoxuron),
N-[[3,5-dichloro-4-(1,1,2,2-tetrafluoroethoxy)phenyl]carbamoyl]-2,6-difluorobenzamide (hexaflumuron),
N-[[2,5-dichloro-4-(1,1,2,3,3,3-hexafluoropropoxy)phenyl]carbamoyl]-2,6-difluorobenzamide (lufenuron).
N-[[2-chloro-3,5-bis(trifluoromethyl)phenyl]carbamoyl]-2,6-difluorobenzamide (Bistrifluron),
N-[[3,5-dichloro-4-[3-chloro-5-(trifluoromethyl)pyridin-2-yl]oxyphenyl]carbamoyl]-2,6-difluorobenzamide (Chlorfluazuron),
N-[[4-[[(E)-[(4-chlorophenyl)-cyclopropylmethylidene]amino]oxymethyl]phenyl]carbamoyl]-2,6-difluorobenzamide (Flucycloxuron)
N-[[3-chloro-4-[1,1,2-trifluoro-2-(trifluoromethoxy)ethoxy]phenyl]carbamoyl]-2,6-difluorobenzamide (Novaluron),
N-[[3,5-dichloro-2-fluoro-4-(1,1,2,3,3,3-hexafluoropropoxy)phenyl]carbamoyl]-2,6-difluorobenzamide (Noviflumuron), and
2-chloro-N-[[4-(trifluoromethoxy)phenyl]carbamoyl]benzamide (Triflumuron)

Preferably, the benzoylurea insecticide is selected from teflubenzuron.

In some embodiments of the present invention, the neonicotinoid insecticide is selected from
(NZ)-N-[3-[(2-chloro-1,3-thiazol-5-yl)methyl]-5-methyl-1,3,5-oxadiazinan-4-ylidene]nitramide (thiamethoxam),
N-[(6-chloropyridin-3-yl)methyl]-N′-cyano-N-methyl ethanimidamide (acetamiprid),
1-[(2-chloro-1,3-thiazol-5-yl)methyl]-3-methyl-2-nitroguanidine (clothianidin),
(NE)-N-[1-[(6-chloropyridin-3-yl)methyl]imidazolidin-2-ylidene]nitramide (imidacloprid),
(E)-1-N′-[(6-chloropyridin-3-yl)methyl]-1-N′-ethyl-1-N-methyl-2-nitroethene-1,1-diamine (nitenpyram),
2-(nitromethylidene)-1,3-thiazinane (nithiazine),
[3-[(6-chloropyridin-3-yl)methyl]-1,3-thiazolidin-2-ylidene]cyanamide (thiacloprid), and
hydroxy-[[N′-methyl-N-(oxolan-3-ylmethyl)carbamimidoyl]amino]-oxoazanium (Dinotefuran).

Preferably, the neonicotinoid insecticide is selected from thiamethoxam.

In some embodiments of the present invention, the pyrethroid insecticide is selected from
[(R)-cyano-(3-phenoxyphenyl)methyl](1S,3S)-3-[(Z)-2-chloro-3,3,3-trifluoroprop-1-enyl]-2,2-dimethylcyclopropane-1-carboxylate (lambda-cyhalothrin),
(2,3,5,6-tetrafluoro-4-methylphenyl)methyl3-[(Z)-2-chloro-3,3,3-trifluoroprop-1-enyl]-2,2-dimethylcyclopropane-1-carboxylate (tefluthrin),
[cyano-(4-fluoro-3-phenoxyphenyl)methyl]3-(2,2-dichloroethenyl)-2,2-dimethylcyclopropane-1-carboxylate (cyfluthrin),
[cyano-(3-phenoxyphenyl)methyl]3-(2,2-dichloroethenyl)-2,2-dimethylcyclopropane-1-carboxylate (cypermethrin),
[cyano-(3-phenoxyphenyl)methyl]2,2,3,3-tetramethylcyclopropane-1-carboxylate (fenpropathrin),
(2-methyl-3-phenylphenyl)methyl3-[(Z)-2-chloro-3,3,3-trifluoroprop-1-enyl]-2,2-dimethylcyclopropane-1-carboxylate (Bifenthrin), and
[(S)-cyano-(3-phenoxyphenyl)methyl](1R,3R)-3-(2,2-dibromoethenyl)-2,2-dimethylcyclopropane-1-carboxylate (Deltamethrin).

Preferably, the pyrethroid insecticide is selected from lambda-cyhalothrin.

In some embodiments of the present invention, the phenoxy herbicide is selected from
Dimethylammonium (2,4-dichlorophenoxy) acetate (2,4-D DMA),
methyl 2-[4-[3-chloro-5-(trifluoromethyl)pyridin-2-yl]oxyphenoxy]propanoate (Haloxyfop-P-methyl),
2,4-dichlorophenoxyacetic acid (2,4-D),
4-(2,4-dichlorophenoxy)butyric acid (2,4-DB),
(R)-2-(2,4-dichlorophenoxy)propanoic acid (dichlorprop),
(4-chloro-2-methylphenoxy)acetic acid (MCPA),
4-(4-chloro-2-methylphenoxy)butyric acid (MCPB), and
(RS)-2-(4-Chloro-2-methylphenoxy)propanoic acid (mecoprop).

Preferably, the phenoxy herbicide is selected from dimethylammonium (2,4-dichlorophenoxy) acetate (2,4-D DMA) or Haloxyfop-P-methyl.

In some embodiments of the present invention, the pyrimidinedione herbicide is selected from
2-chloro-4-fluoro-5-[3-methyl-2,6-dioxo-4-(trifluoromethyl) pyrimidin-1-yl]-N-[methyl(propan-2-yl)sulfamoyl]benzamide (saflufenacil).

In some embodiments of the present invention, the sulfonylurea herbicide is selected from
ethyl 2-[(4-chloro-6-methoxypyrimidin-2-yl)carbamoylsulfamoyl]benzoate (chlorimuron-ethyl),
methyl 2-[(4,6-dimethoxypyrimidin-2-yl)carbamoylsulfamoylmethyl]benzoate (bensulfuron methyl),
1-(2-chlorophenyl)sulfonyl-3-(4-methoxy-6-methyl-1,3,5-triazin-2-yl)urea (chlorsulfuron),
methyl 2-[[4-ethoxy-6-(methylamino)-1,3,5-triazin-2-yl]carbamoyl sulfamoyl]benzoate (ethametsulfuron methyl),
2-[(4,6-dimethoxypyrimidin-2-yl)carbamoylsulfamoyl]-4-formamido-N,N-dimethylbenzamide (foramsulfuron),
3-chloro-5-[(4,6-dimethoxypyrimidin-2-yl)carbamoylsulfamoyl]-1-methylpyrazole-4-carboxylic acid (halosulfuron),
methyl2-[(4,6-dimethoxypyrimidin-2-yl)carbamoylsulfamoyl]-4-(methanesulfonamidomethyl)benzoate (mesosulfuron methyl),
methyl2-[(4-methoxy-6-methyl-1,3,5-triazin-2-yl)carbamoyl sulfamoyl]benzoate (metsulfuron methyl),
2-(4,6-dimethoxypyrimidin-2-ylcarbamoylsulfamoyl)-N,N-dimethyl nicotinamide (nicosulfuron),
oxetan-3-yl 2-[(4,6-dimethylpyrimidin-2-yl)carbamoylsulfamoyl]benzoate (oxasulfuron),
methyl 2-[[4,6-bis(difluoromethoxy)pyrimidin-2-yl]carbamoyl sulfamoyl]benzoate (primisulfuron methyl),
1-(4-methoxy-6-methyl-1,3,5-triazin-2-yl)-3-[2-(3,3,3-trifluoropropyl)phenyl]sulfonylurea (prosulfuron),
1-(4,6-dimethoxypyrimidin-2-yl)-3-(3-ethylsulfonylpyridin-2-yl)sulfonylurea (rimsulfuron),
methyl 2-[(4,6-dimethylpyrimidin-2-yl)carbamoylsulfamoyl]benzoate (sulfometuron methyl),
1-(4,6-dimethoxypyrimidin-2-yl)-3-(2-ethylsulfonylimidazo [1,2-a]pyridin-3-yl)sulfonylurea (sulfosulfuron),
methyl 3-[(4-methoxy-6-methyl-1,3,5-triazin-2-yl)carbamoyl sulfamoyl]thiophene-2-carboxylate (thifensulfuron methyl),
1-[2-(2-chloroethoxy)phenyl]sulfonyl-3-(4-methoxy-6-methyl-1,3,5-triazin-2-yl)urea (triasulfuron), and
methyl 2-[[4-(dimethylamino)-6-(2,2,2-trifluoroethoxy)-1,3,5-triazin-2-yl]carbamoylsulfamoyl]-3-methylbenzoate (triflusulfuron methyl).

Preferably, the sulfonylurea herbicide is selected from chlorimuron-ethyl.

In some embodiments of the present invention, the cyclohexadione herbicide is selected from:
2-[(E)-N-[(E)-3-chloroprop-2-enoxy]-C-ethylcarbonimidoyl]-5-(2-ethylsulfanylpropyl)-3-hydroxycyclohex-2-en-1-one (clethodim),
2-[(E)-N-[(E)-3-chloroprop-2-enoxy]-C-ethylcarbonimidoyl]-3-hydroxy-5-(oxan-4-yl)cyclohex-2-en-1-one (Tepraloxydim)
5-(3-butanoyl-2,4,6-trimethylphenyl)-2-[(E)-N-ethoxy-C-ethylcarbonimidoyl]-3-hydroxycyclohex-2-en-1-one (Butroxydim)
2-[(E)-N-ethoxy-C-propylcarbonimidoyl]-5-(2-ethylsulfanylpropyl)-3-hydroxycyclohex-2-en-1-one (Sethoxydim)
2-[(E)-N-ethoxy-C-propylcarbonimidoyl]-3-hydroxy-5-(thian-3-yl)cyclohex-2-en-1-one (Cicloxydim)
2-[N-[2-(4-chlorophenoxy)propoxy]-C-propylcarbonimidoyl]-3-hydroxy-5-(thian-3-yl)cyclohex-2-en-1-one (Profoxydim), and
2-[(E)-N-ethoxy-C-ethylcarbonimidoyl]-3-hydroxy-5-(2,4,6-trimethylphenyl)cyclohex-2-en-1-one (Tralkoxydim)

Preferably, the cyclohexadione herbicide is selected from clethodim.

In some embodiments of the present invention, the benzoic acid herbicide is selected from:
3-amino-2,5-dichlorobenzoic acid (chloramben),
3,6-dichloror-2-methoxybenzoic acid (dicamba),
2,3,6-trichlorobenzoic acid (2,3,6-TBA), and
2,3,5-trichloro-6-methoxybenzoic acid (tricamba).

Preferably, the benzoic acid herbicide is selected from dicamba.

According to one advantage embodiment of the present invention, the weight ratio of the compatibilizer composition comprises from 50 to 90% of a copolymer comprising units of diisobutylene and methacrylic anhydride or methacrylic acid and from 10 to 50% of C10-C16 alkyl ether sulfate salt based on the total weight of the compatibilizer composition.

The agricultural tank-mix composition according to the present invention may optionally further contain one or more fertilizers, chosen from water-soluble or non-water soluble fertilizers including single nutrient, multinutrient or macronutrient fertilizers.

In one preferred embodiment of the present invention, the component a) is selected from the combination of glyphosate, dithiocarbamate fungicide, flumioxazine, strobilurin fungicide, pyrazole-carboxamide fungicide, benzoylurea insecticide, neonicotinoid insecticide, pyrethroid insecticide, phenoxy herbicide, pyrimidinedione herbicide, cyclohexanedione herbicide and sulfonylurea herbicide which are illustrated as above.

In one preferred embodiment of the present invention, the component a) is selected from the combination of mancozeb, azoxystrobin and benzovindiflupyr.

In another preferred embodiment of the present invention, the component a) is selected from the combination of mancozeb, azoxystrobin, benzovindiflupyr and teflubenzuron.

In another preferred embodiment of the present invention, the component a) is selected from mancozeb, azoxystrobin, benzovindiflupyr, thiamethoxam and lambda-cyhalothrin.

In another preferred embodiment of the present invention, the component a) is selected from the combination of glyphosate potassium salt and teflubenzuron.

In still another preferred embodiment of the present invention, the component a) is selected from the combination of glyphosate potassium salt, 2,4-D DMA, saflufenacil and chlorimuron-ethyl.

In still another preferred embodiment of the present invention, the component a) is selected from the combination of glyphosate potassium salt, clethodim and saflufenacil or flumioxazine.

In another preferred embodiment of the present invention, the component a) is selected from the combination of glyphosate potassium salt, haloxyfop-p-methyl and saflufenacil or flumioxazine.

In some other preferred embodiments of the present invention, the component a) is selected from the combination of glyphosate potassium salt or glyphosate ammonium salt and clethodim or haloxyfop-p-methyl or 2,4-D DMA.

In still another preferred embodiments of the present invention, the component a) is selected from the combination of glyphosate ammonium salt, clethodim and saflufenacil.

The herbicides as illustrated can be formulated in any formulation form which is applicable in tank-mix application, for example including but not limited to emulsifiable concentrate (EC), soluble liquid (SL), suspension concentrate (SC), wettable powder (WP) or water dispersible granules (WG or WDG).

In another aspect of the present invention, it is provided the use of a composition comprising a copolymer comprising units of diisobutylene and methacrylic anhydride or methacrylic acid and C10-C16 alkyl ether sulfate salt as compatibilizer to stabilize the agricultural active composition.

In still another aspect of the present invention, it is provided a process of preparing a tank mix composition, comprising the steps of mixing a composition comprising a copolymer comprising units of diisobutylene and methacrylic anhydride or methacrylic acid and C10-C16 alkyl ether sulfate salt as compatibilizer with an agricultural active composition.

### EXAMPLES

The following materials are used in the experiments:

Compatibilizer: composition of a copolymer of 90% of di-isobutylene/methacrylic anhydride and methacrylic acid and 10% sodium alkyl C10-C16 ether sulfate, available from Solvay (provided as a liquid composition containing 30 weight % of the copolymer, based on total volume of the compatibilizer).

### Example 1

### Preparation of the Agricultural Tank-Mix Composition

The simulated “tank” (graduated cylinder) was filled to 70% with 342 ppm water. The compatibilizer composition was added at 1% v/v (volume), based on the total volume of the tank-mix composition. The formulations were then added, according to their type—WP first, then WDG/WGs, then SCs, SLs, ECs and finally any adjuvant recommended by the formulations. The cylinder was inverted 10 times every time new products were added to the “tank”. The “tank” was made up to volume with 342 ppm water and given a final 10 inversions prior to measurement start. A number of tank mix compositions were prepared according to Table 1. All the pesticides formulations are commercially available from the market.

TABLE 1
Tank Mix compositions

| Tank | TM | TM | TM | TM | TM | TM | TM | TM | TM | TM | TM | TM | TM | TM |
|---|---|---|---|---|---|---|---|---|---|---|---|---|---|---|
| Mix | 01 | 02 | 03 | 04 | 05 | 06 | 07 | 08 | 09 | 10 | 11 | 12 | 13 | 14 |
| Compatibilizer | 1.00% | 1.00% | 1.00% | 1.00% | 1.00% | 1.00% | 1.00% | 1.00% | 1.00% | 1.00% | 1.00% | 1.00% | 1.00% | 1.00% |
| Azoxystrobin | 0.30 | 0.30 | 0.30 | — | — | — | — | — | — | — | — | — | — | — |
| + | Kg/ha | Kg/ha | Kg/ha | | | | | | | | | | | |
| Benzo- | | | | | | | | | | | | | | |
| vindiflupyr | | | | | | | | | | | | | | |
| Mancozeb | 3.00 | 3.00 | 3.00 | — | — | — | — | — | — | — | — | — | — | — |
| | Kg/h | Kg/h | Kg/h | | | | | | | | | | | |
| Saflufenacil | — | — | — | — | 50.00 | 50.00 | — | 50.00 | — | — | — | — | — | 50.00 |
| | | | | | g/ha | g/ha | | g/ha | | | | | | g/ha |
| Chlorimuron- | — | — | — | — | 70.00 | — | — | — | — | — | — | — | — | — |
| ethyl | | | | | g/ha | | | | | | | | | |
| Glyphosate, | — | — | — | — | — | — | — | — | — | — | — | — | 2.00 | 2.00 |
| ammonium | | | | | | | | | | | | | Kg/ha | Kg/ha |
| salt | | | | | | | | | | | | | | |
| Teflubenzuron | — | 0.15 | — | 0.15 | — | — | — | — | — | — | — | — | — | — |
| | | L/ha | | L/ha | | | | | | | | | | |
| Flumioxazine | — | — | — | — | — | — | 0.10 | — | 0.10 | — | — | — | — | — |
| | | | | | | | L/ha | | L/ha | | | | | |
| Thiamethoxam | — | — | 0.20 | — | — | — | — | — | — | — | — | — | — | — |
| + | | | L/ha | | | | | | | | | | | |
| Lambda- | | | | | | | | | | | | | | |
| cyhalothrin | | | | | | | | | | | | | | |
| Glyphosate, | — | — | — | 2.90 | 2.90 | 2.90 | 2.90 | 2.90 | 2.90 | 2.90 | 2.90 | 2.90 | — | — |
| K | | | | L/ha | L/ha | L/ha | L/ha | L/ha | L/ha | L/ha | L/ha | L/ha | | |
| salt | | | | | | | | | | | | | | |
| 2,4-D, | — | — | — | — | 2.10 | — | — | — | — | — | — | 2.10 | 2.10 | — |
| DMA | | | | | L/ha | | | | | | | L/ha | L/ha | |
| salt | | | | | | | | | | | | | | |
| Clethodim | — | — | — | — | — | 0.40 | 0.40 | — | — | 0.40 | — | — | — | 0.40 |
| | | | | | | L/ha | L/ha | | | L/ha | | | | L/ha |
| Haloxyfop-P- | — | — | — | — | — | — | — | 0.20 | 0.20 | — | 0.20 | — | — | — |
| methyl | | | | | | | | L/ha | L/ha | | L/ha | | | |
| Fungicide | 0.25% | 0.25% | 0.25% | — | — | — | — | — | — | — | — | — | — | — |
| tank | | | | | | | | | | | | | | |
| mix | | | | | | | | | | | | | | |
| partner | | | | | | | | | | | | | | |
| Mineral | — | — | — | 0.50% | 0.50% | 0.50% | 0.50% | 0.50% | 0.50% | 0.50% | 0.50% | — | — | 0.50% |
| oil | | | | | | | | | | | | | | |

These tests were carried out with a spray volume of 100 L/ha.

### Example 2

### Compatibility Determination Process

Compatibility was determined by the amount of sedimentation, crystallization, presence of solids on the sieve or any other separation observed immediately, after 2 hours at rest and 24 h at rest. That is, if the addition of the compatibilizer reduced the amount of sediment after 24 hours at rest and reduced the presence of solids on the sieve, it was deemed to be aiding in compatibility.

After 2 h and 24 h of static testing, the measuring cylinders were inverted 10 times before being passed through a 149μm sieve. Retention on the sieve was visually observed as present or absent, as well as any oil residue, crystals or inability for the liquid to pass through the sieve (if the sediment had blocked it completely).

The compatibility test result was listed in Table 2 as below.

TABLE 2
compatibility test results:

| Tank Mix | Inicial | | After 2 hours at rest | | After 24 hours at rest | | |
|---|---|---|---|---|---|---|---|
| Cases | Appearance | pH | Appearance | pH | Appearance | pH | Sieve test |
| TM 01- | Homogeneous- | 6.8 | Precipitation = | 6.8 | Precipitation = | 7.1 | Present |
| Without | less than | | 4 mm | | 6 mm | | |
| compatibilizer | 1 mm of | | | | | | |
| | precipitation | | | | | | |
| TM 01-With | Homogeneous- | 7.0 | Precipitation = | 7.1 | Precipitation = | 7.1 | Present, but |
| compatibilizer | less than | | 2 mm | | 2 mm | | reduced |
| | 1 mm of | | | | | | |
| | precipitation | | | | | | |
| TM 02- | Precipitation = | 7.1 | Precipitation = | 7.2 | Precipitation = | 7.2 | Present |
| Without | 1 mm | | 5 mm | | 10 mm | | |
| compatibilizer | | | | | | | |
| TM 02-With | Homogeneous- | 7.3 | Precipitation = | 7.4 | Precipitation = | 7.5 | Present, but |
| compatibilizer | less than | | 2 mm | | 2 mm | | reduced |
| | 1 mm of | | | | | | |
| | precipitation | | | | | | |
| TM 03- | Homogeneous | 7.3 | Precipitation = | 7.3 | Precipitation = | 7.2 | Present |
| Without | | | 5 mm | | 12 mm | | |
| compatibilizer | | | | | | | |
| TM 03-With | Homogeneous | 7.3 | Precipitation = | 7.3 | Precipitation = | 7.3 | Present, but |
| compatibilizer | | | 2 mm | | 4 mm | | reduced |
| TM 04- | Homogeneous | 4.7 | 2 phases | 4.7 | 2 phases | 4.7 | Present |
| Without | | | separation: | | separation: Liquid | | |
| compatibilizer | | | Liquid separation | | separation in the | | |
| | | | in the top and | | top and | | |
| | | | precipitation | | precipitation | | |
| TM 04-With | Homogeneous | 4.9 | Homogeneous | 4.9 | Homogeneous | 4.9 | Absent |
| compatibilizer | | | | | | | |
| TM 05- | Homogeneous | 4.6 | Precipitation = | 4.7 | Precipitation = | 4.7 | Present |
| Without | | | 2 mm | | 5 mm | | |
| compatibilizer | | | | | | | |
| TM 05-With | Homogeneous | 4.7 | Homogeneous | 4.7 | Less than 1 mm of | 4.7 | Absent |
| compatibilizer | | | | | precipitation | | |
| TM 06- | Homogeneous | 4.7 | 2 phases | 4.6 | 2 phases | 4.7 | Present |
| Without | | | separation: | | separation: Liquid | | |
| compatibilizer | | | Liquid separation | | separation in the | | |
| | | | in the top and | | top and | | |
| | | | precipitation | | precipitation | | |
| TM 06-With | Homogeneous | 4.8 | Homogeneous | 4.8 | Homogeneous | 4.9 | Absent |
| compatibilizer | | | | | | | |
| TM 07- | Homogeneous | 4.7 | 2 phases | 4.7 | 2 phases | 4.7 | Present |
| Without | | | separation: | | separation: Liquid | | |
| compatibilizer | | | Liquid separation | | separation in the | | |
| | | | in the top and | | top and | | |
| | | | precipitation | | precipitation | | |
| TM 07-With | Homogeneous | 4.9 | Homogeneous | 4.9 | Homogeneous | 4.9 | Absent |
| compatibilizer | | | | | | | |
| TM 08- | Homogeneous | 4.7 | 2 separation | 4.6 | 2 separation | 4.9 | Present |
| Without | | | phases: Liquid | | phases: Liquid | | |
| compatibilizer | | | separation in the | | separation in the | | |
| | | | top and | | top and | | |
| | | | precipitation | | precipitation | | |
| TM 08-With | Homogeneous | 4.9 | Homogeneous | 4.9 | Homogeneous | 4.8 | Absent |
| compatibilizer | | | | | | | |
| TM 09- | Homogeneous | 4.7 | 2 phases | 4.7 | 2 phases | 4.7 | Present |
| Without | | | separation: | | separation: Liquid | | |
| compatibilizer | | | Liquid separation | | separation in the | | |
| | | | in the top and | | top and | | |
| | | | precipitation | | precipitation | | |
| TM 09-With | Homogeneous | 4.9 | Homogeneous | 4.9 | Homogeneous | 4.9 | Absent |
| compatibilizer | | | | | | | |
| TM 10- | Homogeneous | 4.7 | 2 phase | 4.6 | 2 phase | 4.7 | Present |
| Without | | | separations: | | separations: Liquid | | |
| compatibilizer | | | Liquid separation | | separation in the | | |
| | | | in the top and | | top and liquid | | |
| | | | liquid separation | | separation in the | | |
| | | | in the bottom | | bottom | | |
| TM 10-With | Homogeneous | 4.9 | Homogeneous | 4.9 | Homogeneous | 4.9 | Absent |
| compatibilizer | | | | | | | |
| TM 11- | Homogeneous | 4.6 | 2 phase | 4.6 | 2 phase | 4.6 | Absent |
| Without | | | separations: | | separations: Liquid | | |
| compatibilizer | | | Liquid separation | | separation in the | | |
| | | | in the top and | | top and liquid | | |
| | | | liquid separation | | separation in the | | |
| | | | in the bottom | | bottom | | |
| TM 11-With | Homogeneous | 4.9 | Homogeneous | 4.9 | Homogeneous | 4.9 | Absent |
| compatibilizer | | | | | | | |
| TM 12- | Homogeneous | 4.5 | Crystallization | 4.6 | Crystallization | 4.8 | Present |
| Without | | | | | | | |
| compatibilizer | | | | | | | |
| TM 12-With | Homogeneous | 4.8 | Homogeneous | 4.8 | Homogeneous | 4.9 | Absent |
| compatibilizer | | | | | | | |
| TM 13- | Homogeneous | 4.1 | Precipitation = | 4.1 | Precipitation = | 4.2 | Present |
| Without | | | 4 mm | | 6 mm | | |
| compatibilizer | | | | | | | |
| TM 13-With | Homogeneous | 4.3 | Homogeneous | 4.3 | Homogeneous | 4.3 | Absent |
| compatibilizer | | | | | | | |
| TM 14- | Homogeneous | 3.5 | 2 separation | 3.5 | 2 separation | 3.6 | Present |
| Without | | | phases: Liquid | | phases: Liquid | | |
| compatibilizer | | | separation in the | | separation in the | | |
| | | | top and | | top and | | |
| | | | precipitation | | precipitation | | |
| TM 14-With | Homogeneous | 4.1 | Homogeneous | 4.1 | Homogeneous | 4.1 | Absent |
| compatibilizer | | | | | | | |

It was demonstrated by the Table 2 a great decrease or even no observation of the presence of precipitate, crystal materials, solid retention on sieve or any other incompatibility in the compositions containing the compatibilizer.

Therefore, the tank-mix compositions comprising the compatibilizer have improved compatibility over those without adding the compatibilizer.

1. An agricultural tank-mix composition, comprising:
a) an agricultural active composition comprising at least two pesticides selected from dithiocarbamate fungicide, chlorothalonil, glyphosate, flumioxazine, strobilurin fungicide, pyrazole-carboxamide fungicide, benzoylurea insecticide, neonicotinoid insecticide, pyrethroid insecticide, phenoxy herbicide, pyrimidinedione herbicide, sulfonylurea herbicide, cyclohexanediones herbicide and benzoic acid herbicide, and
b) a compatibilizer selected from a composition comprising a copolymer comprising units of diisobutylene and methacrylic anhydride or methacrylic acid and C10-C16 alkyl ether sulfate salt, wherein the copolymer is present in an amount of ranging from 0.1 to 5 wt. % based on a total weight of the agricultural tank-mix composition.

2. The agricultural tank-mix composition according to claim 1, wherein the dithiocarbamate is selected from mancozeb, ferbam, maneb, metam, metiram, propineb, thiram, zineb, ziram.

3. The agricultural tank-mix composition according to claim 1, wherein the dithiocarbamate is in the form of solid composition containing in the range of from 0.5 to 1000 g/kg dithiocarbamate.

4. The agricultural tank-mix composition according to claim 1, wherein the chlorothalonil in the form of liquid aqueous composition containing in the range of from 300 to 800 g/l chlorothalonil.

5. The agricultural tank-mix composition according to claim 1, wherein the glyphosate is present in the salt form and selected from potassium (K) salt, sodium (Na) salt, isopropylamine (IPA) salt, monoethanolamine (MEA) salt, monomethylamine (MMA) salt, triethylamine (TEA) salt, dimethylamine (DMA) salt, trimethylsulphonium salt, and ammonium (NH₃) salt.

6. The agricultural tank-mix composition according to claim 1, wherein the glyphosate is in the form of an aqueous solution containing in the range of from 300 to 700 g/l (ae) glyphosate.

7. The agricultural tank-mix composition according to claim 1, wherein the strobilurin fungicide is selected from azoxystrobin, kresoxim-methyl, picoxystrobin, fluoxastrobin, orysastrobin, dimoxystrobin, pyraclostrobin or trifloxystrobin.

8. The agricultural tank-mix composition according to claim 1, wherein the pyrazole-carboxamide fungicide is selected from benzovindiflupyr, fluxapyroxad, bixafen or inpyrfluxam.

9. The agricultural tank-mix composition according to claim 1, , wherein the benzoylurea insecticide is selected from teflubenzuron, diflubenzuron, flufenoxuron, hexaflumuron or lufenuron, bistrifluron, chlorfluazuron, flucycloxuron, novaluron, noviflumuron or triflumuron.

10. The agricultural tank-mix composition according to claim 1, wherein the neonicotinoid insecticide is selected from thiamethoxam, acetamiprid, clothianidin, imidacloprid, nitenpyram, nithiazine, thiacloprid or dinotefuran.

11. The agricultural tank-mix composition according to claim 1, wherein the pyrethroid insecticide is selected from lambda-cyhalothrin, tefluthrin, cyfluthrin, cypermethrin or fenpropathrin.

12. The agricultural tank-mix composition according to claim 1, wherein the phenoxy herbicide is selected from dimethylammonium (2,4-dichlorophenoxy) acetate (2,4-D DMA), 2,4-dichlorophenoxyacetic acid (2,4-D), 2,4-DB, dichlorprop, MCPA, MCPB or Mecoprop.

13. The agricultural tank-mix composition according to claim 1, wherein the pyrimidinedione herbicide is selected from saflufenacil.

14. The agricultural tank-mix composition according to claim 1, wherein the sulfonylurea herbicide is selected from chlorimuron-ethyl, bensulfuron methyl, chlorsulfuron, ethametsulfuron methyl, foramsulfuron, halosulfuron, mesosulfuron methyl, metsulfuron methyl, nicosulfuron, oxasulfuron, primisulfuron methyl, prosulfuron, rimsulfuron, sulfometuron methyl, sulfosulfuron, thifensulfuron methyl, triasulfuron or triflusulfuron methyl.

15. The agricultural tank-mix composition according to claim 1, wherein the cyclohexanedione herbicide is selected from clethodim, tepraloxydim, butroxydim, sethoxydim, cicloxydim, profoxydim or tralkoxydim.

16. The agricultural tank-mix composition according to claim 1, wherein the benzoic acid herbicide is selected from chloramben, dicamba, 2,3,6-TBA or tricamba.

17. The agricultural tank-mix composition of claim 1, wherein the weight ratio of the compatibilizer composition b) comprises from 50 to 90% of a copolymer comprising units of diisobutylene and methacrylic anhydride or methacrylic acid and from 10 to 50% of C10-C16 alkyl ether sulfate salt based on the total weight of the compatibilizer composition.

18. The agricultural tank-mix composition according to claim 1, optionally comprising at least one fertilizer.

19. (canceled)

20. A process of preparing a tank-mix composition, comprising the steps of mixing the composition comprising a copolymer comprising units of diisobutylene and methacrylic anhydride or methacrylic acid and C10-C16 alkyl ether sulfate salt as compatibilizer with an agricultural active composition comprising:
a) an agricultural active composition comprising at least two pesticides selected from dithiocarbamate fungicides, chlorothalonil, glyphosate, flumioxazine, estrobilurin fungicide, pyrazole-carboxamide fungicide, benzoylurea insecticide, neonicotinoid insecticide, pyrethroid insecticide, phenoxy herbicide, pyrimidinedione herbicide, sulfonylurea herbicide, cyclohexanediones herbicide and benzoic acid herbicide,
wherein the composition comprising a copolymer comprising units of diisobutylene and methacrylic anhydride or methacrylic acid and C10-C16 alkyl ether sulfate salt is present in an amount of ranging from 0.1 to 5 wt. %, based on the total weight of the agricultural tank-mix composition.
